(19) United States
(12) Patent Application Publication
(10) Pub. No.: US 2007/0201413 A1
(43) Pub. Date: Aug. 30, 2007

(54) Method and system to enhance energy savings in multicast transmissions in WLAN

(75) Inventors: Petri T. Laine, Oulu (FI); Lauri Piikivi, Oulu (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/364,432

(22) Filed: Feb. 27, 2006

(51) Int. Cl. H04Q 7/24; H04L 12/56

(52) U.S. Cl. 370/338; 370/390

(57) ABSTRACT

A new and unique method and apparatus are provided for communicating information between two nodes, points or terminals in a wireless local area network (WLAN) environment or other suitable network environment, featuring one or more steps for creating an association between multicast transmission scheduling and multicast internet protocol (IP) and ethernet addresses within a multicast transmission period, and mapping multicast transmission start times using the multicast IP or ethernet address information. The apparatus may take the form of a wireless local area network (WLAN) or other suitable network having the two nodes or points that communicate information between the same based on the association and mapping, as well as the first or second node, point or terminal in such a wireless local area network (WLAN) environment, or other suitable network environment. The first or second node, point or terminal may include an access point or a station (STA).

### BACKGROUND OF THE INVENTION

1. Field of Invention

The present invention related to a method and apparatus for providing multicast service optimisations in WLAN networks, including that set forth in IEEE 802.11; and more particularly relates to a method and apparatus for enhancing WLAN multicasting operation especially in view of client terminal power saving.

2. Description of Related Art

FIG. 1 shows, by way of example, typical parts of an IEEE 802.11 WLAN system, which is known in the art and provides for communications between communications equipment such as mobile and secondary devices including personal digital assistants (PDAs), laptops and printers, etc. The WLAN system may be connected to a wired LAN system that allows wireless devices to access information and files on a file server or multimedia streaming server other suitable device or connecting to the Internet.

The devices can communicate directly with each other in the absence of a base station in a so-called “ad-hoc” network, or they can communicate through a base station, called an access point (AP) in IEEE 802.11 terminology, with distributed services through the AP using local distributed services (DS) or wide area extended services, as shown. In a WLAN system, end user access devices are known as stations (STAs), which are transceivers (transmitters/receivers) that convert radio signals into digital signals that can be routed to and from communications device and connect the communications equipment to access points (APs) that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

FIGS. 2a and 2b show diagrams of the Universal Mobile Telecommunications System (UMTS) packet network architecture, which is also known in the art. In FIG. 2a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 2b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 2a. A given UE may be in radio contact with multiple Node Bs even if one or more of the Node Bs are connected to different RNCS. For instance, a UE1 in FIG. 2b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 2a and 2b has resulted in STAs taking the form of UEs, such as mobile phones or mobile terminals. The interworking of the WLAN (IEEE 802.11) shown in FIG. 1 with such other technologies (e.g. 3GPP, 3GPP2 or 802.16) such as that shown in FIGS. 2a and 2b is being defined at present in protocol specifications for 3GPP and 3GPP2.

FIG. 3 shows, by way of example, the current multicast system, where an access point (AP) provides signals from a wired network (not shown) as wireless LAN signals to terminals #1, #2 and #3. Current 802.11x WLANs specify that multicast traffic is handled in the same way as broadcast traffic. The problem is that the current multicast functionality in the WLAN causes transmission bursts just after deliver traffic indication message (DTIM) intervals. This causes two problems: First, all stations must be in the receive mode to be able to receive multicast packets. If there are multiple multicast transmissions going on in the network all terminals must stay in the receive mode until the last multicast frame is transmitted. The reason is that the terminal cannot know if there are more packets coming belonging to the same multicast group. The terminal must stay in the receive mode until the last multicast packet is received before it can safely go back to the power save mode. In addition, receiving and discarding unnecessary multicast packets consumes also energy. The terminal must do some amount of processing for each packet to check if that is an interesting one.

The second problem in the current method is that all multicast packets come in burst after the DTIM interval. This is not optimal from a radio spectrum usage point of view. Different multicast transmissions should be distributed more scattered in the time axis.

FIG. 4 illustrates how all the terminals #1, #2, #3 in FIG. 3 listening to any multicast group must receive all multicast packets transmitted in the network. In this example, terminal #2 suffers a lot by this kind of functionality, because it must listen for all multicast packets to get those few packets it is really needs to. In this example, all terminals #1, #2 and #3 spend over half of the total DTIM period in the receive mode. Also the terminals that are not listening to multicast transmissions must receive some packets to get broadcast packets, for example, Address Resolution Protocol (ARP) updates.

When one or more terminals associated with the wireless LAN is in the power save mode, the AP buffers all multicast packets that are going to the wireless LAN. The AP delivers these packets when the next DTIM time comes. Terminals can use DTIM period information and use it to stay in the power save as long as possible. When the terminal is just receiving multicast packets, it can stay in the power save in all the time except the DTIM time. When multicast packets are transmitted at the DTIM time by the AP the last packet does not have a “more data field” bit on. This “more data field” bit marks the end of multicast transmission.

Transmitting data at an agreed time to implement power saving is known prior art from different systems.

In Ethernet and WLAN, each multicast IP address (group address) is mapped to one Ethernet MAC address. Multicast IP addresses are D class addresses from 224.0.0.0 to 239.255.255.255. Corresponding mapping range to Ethernet addresses is 01-00-5E-00-00-00 to 01-00-5E-7F-FF-FF. Mapping is done by taking Ethernet address 01:00:5E:XX:XX:XX and replacing its last three hex numbers by last 23 bits from multicast IP address.

In view of the aforementioned, there is a need in the art for a system in which better power savings could be achieved if the terminal would know exactly when there are multicast transmissions from addresses which the terminal is listening. As a result if this, the mobile terminal could be in the power save mode for a much longer time than in the current system and also avoid receiving unnecessary data packets. From an energy savings point of view, best performance could be achieved if terminal knew exactly when it must return from the power save mode to receive mode. The terminal would also be able to avoid receiving unnecessary packets.

Optimal energy saving is crucial when enabling IPTV TV like services in mobile terminals. Power consumption in WLAN chip is much different in the power-save and receive mode. Typically, WLAN chip consumes a few mW in the power save mode and hundreds of mWs in the receive mode.

### SUMMARY OF THE INVENTION

In its broadest sense, the present invention provides a new and unique method and apparatus for communicating information between two nodes, points or terminals in a wireless local area network (WLAN) environment or other suitable network environment, featuring one or more steps for creating an association between multicast transmission scheduling and multicast internet protocol (IP) or ethernet addresses within a multicast transmission period, and mapping multicast transmission start times using the multicast IP or ethernet address information.

The apparatus may take the form of a wireless local area network (WLAN) or other suitable network having the two nodes or points that communicate information between the same based on the association and mapping, as well as the first or second node, point or terminal in such a wireless local area network (WLAN) environment, or other suitable network environment. The first or second node, point or terminal may include an access point or a station (STA).

The whole thrust of the present invention is how the IP multicast transmission is easily mapped to timed wireless delivery enabling improved power saving, and how the multicast IP or ethernet address is used to do this mapping.

According to the present invention, the multicast transmission period is split into a number of time slots, each slot having one or more associated multicast addresses, where the number of time slots depends on the length of the multicast transmission period, and where the multicast transmission period is the deliver traffic indication message (DTIM) period in the WLAN environment. The multicast transmissions are distributed to different time slots based on a multicast address of a packet.

In operation, each multicast packet transmitted has a multicast transmission map of bits containing information about which multicast slots have more packets pending. The multicast transmission map can be used by any node, point or terminal to immediately detect if there is still interesting packets coming in this cycle, such that a receiving terminal uses the same algorithm as a transmitting device to detect when to be in the receive mode. A receiving terminal can use this information for making a decision whether it should stay in the receive mode or whether it can go to the power save mode and wait for next time slot.

In effect, according to the present invention a transmitting device (AP) and receiving devices (mobile terminals) have prenegotiated general rules when transmissions to various multicast groups will be effective within the DTIM period length dedicated for multicast transmissions. The prenegotiation is based on the multicast IP or ethernet address, which can be used to map multicast transmission times for various multicast groups. Both the transmitting device (AP) and the receiving devices (mobile terminals) have prestored a dedicated algorithm (factory assembled, or negotiated on the fly), which is used for calculating the transmission start times within the DTIM period based on the Multicast IP or ethernet address. With the knowledge of the multicast IP or ethernet address of the multicast group, the receiving devices can know exactly the intended starting times for multicast transmissions for the specific multicast group.

The present invention also provides an embodiment wherein a node, point or terminal changes the multicast transmission period dynamically. The node, point or terminal may be an access point in the WLAN and the multicast transmission period is the deliver traffic indication message, and the modification is based on the amount and/or direction of the multicast traffic going to the WLAN.

One advantage of the present invention is that it provides a technique to determine how multicast traffic can be transmitted in the WLAN in a way that problems in the prior art described above can be avoided. For example, by using the technique of the present invention the terminal can avoid receiving and processing most unnecessary data packets. The terminal can also stay in the power save mode for a longer time. The present invention focuses to improve AP originating multicast traffic, which is believed to be the most important direction where greatest energy saving can be achieved. Moreover, the present invention enables the terminal originated multicast traffic and AP originated unicast traffic to work as it works in current 802.11 specifications.

The present invention has applications in IPTV like video distribution over WLAN network, and provides a mechanism for enhancing WLAN multicast performance to take account battery powered mobile terminals. The aim is to improve current multicast performance from an energy saving point of view. For example, the present invention may be used in IPTV like video or audio streaming using scalable IP multicast. Multicast is good for this kind of delivery, because receiving terminals do not have to acknowledge each received packets as they do with unicast packets. This allows receivers to consume much less energy if compared to unicast reception. Energy consumption is critical issue when building IPTV like services for mobile terminals.

Moreover, although the present invention is described for 802.11 WLAN, the basic idea may be used also in other unidirectional or bi-directional radio transmission networks to deliver scalable IP multicast traffic, taking advantage of the key idea to transmit multicast packets in certain time slots so that the receiver can switch its receiver circuitry on at specific time to receive packets from a certain multicast address. Distribution of IP packets to these slots can be calculated directly from packets IP address. IP address information is all that is needed by receivers to perform optimal energy saving pattern based on their multicast group join status. Because all entities can calculate transmission time independently, there is no need exchange information about transmission times. This allows this distribution mechanism to work also with unidirectional wired or wireless bearer.

In summary, the key points in the present invention are as follows:

1) Multicast address is used to calculate the MTMAP, where the method to do this calculation is known by all entities. This allows this mechanism to work also with unidirectional bearer, and there is no need to send information from the receiving terminal to the AP to subscribe packet sending.

2) Multicast packet sending starts only at time points told by MTMAP, which allows terminals to avoid receiving unnecessary packets. Multicast transmission can span over into the next slots where the AP can continue sending in the following slots. In the case when transmission spans over into next slots and there are packets waiting for transmission starting in the next slots, the AP can decide and prioritize the transmission order of the packets belonging to different slots. This sending may also span over the DTIM period limit.

### BRIEF DESCRIPTION OF THE DRAWING

The drawing includes the following Figures, which are not necessarily drawn to scale:

FIG. 1 shows typical parts of an IEEE 802.11 WLAN system, which is known in the art.

FIGS. 2a and 2b show diagrams of the Universal Mobile Telecommunications System (UMTS) packet network architecture, which is also known in the art.

FIG. 3 shows the current WLAN multicast system.

FIG. 4 shows an example of section 802.11 WLAN multicast transmission.

FIG. 5 shows an example of an enhanced multicast transmission according to the present invention.

FIG. 6 shows an access point (AP) according to the present invention.

FIG. 7 shows a station (STA) according to the present invention.

FIG. 8 shows an example of changing DTIM period length at runtime according to the present invention.

### BEST MODE OF THE INVENTION

The present invention provides a new and unique method and apparatus for communicating information between two nodes, STAs, points or terminals in a wireless local area network (WLAN), featuring one or more steps for creating an association between multicast transmission scheduling and multicast internet protocol (IP) addresses within a multicast transmission period, and mapping multicast transmission start times using the multicast IP or ethernet address information.

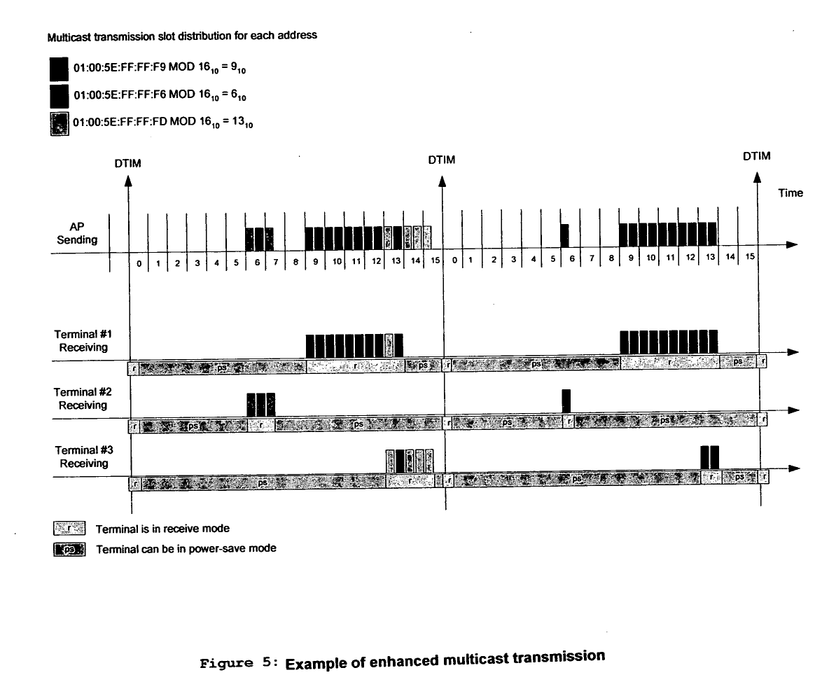

FIG. 5 shows an example of the enhanced multicast transmission according to the present invention, where the DTIM period is split into a certain amount of time slots, each time slot having associated to it certain multicast addresses. As shown, the DTIM period is split, for example, into 16 time slots labelled 0, 1, 2, . . . , 15. The number of these slots may depend on the DTIM period length. In view of this, the scope of the invention is not intended to be limited to 16 time slots, because embodiments are envisioned using another number of time slots. The AP sends and distributes multicast transmissions start times to different time slots based on a packet's multicast address, consistent with that shown and described herein. There may be more traffic in one multicast group than can fit into one slots, so transmission can continue in following slots mixing with next slots transmissions.

Moreover, each multicast IP or ethernet address (group address) is mapped to one Ethernet MAC address, and the Ethernet address is used to distribute packet transmission times to certain time slots, known also by receiving terminals. Each terminal knows which multicast addresses it is listening to and, based on that information, the terminal can calculate the time when it must be in the receiving mode to be able to receive packets. The terminal can turn its receiver off at other times and go to the power save mode.

In operation, the WLAN access point buffers all wireless LAN destined multicast packets. The AP starts delivering these packets only when a multicast transmission slot for the packet's address is going on. The AP can continue transmissions in following slots if the volume of transmissions of multicast groups exceeds a slot size. The AP can send unicast traffic at any time. Also other terminals, associated with the AP, can send uplink unicast packets following existing unicast-sending rules.

Each multicast packet transmitted by the AP has a map of bits providing information about which multicast slots have more packets pending. This pending packets bitmap can be used by any terminal to immediately detect if there is still interesting packets coming in this cycle. Every receiving terminal can use this information for making a decision whether it should stay in the receive mode or whether it can go to the power save mode and wait for the next cycle. Delivering this bitmap in each packet minimizes damage caused by packet loss. Terminals need only to receive one multicast packet more or next DTIM to make a power save decision. Because multicast packets are not acknowledged by the receiver, the system must prepare for lost packets is each step.

In particular, the map may take the form of a multicast transmission map (MTMAP), which is a bitmap that is delivered in each multicast packet. This map has pending packets bits (0, . . . , n), where the location of a bit represents a slot number and the value of the bit represents if the AP has buffered packets for that slot. When the slots bit is enabled, the AP can freely deliver multicast packets associated with that slot. When the AP has sent a first packet having this bit disabled, the AP must buffer packets associated to that slot until the slot time comes next time.

One way to calculate the MTMAP is to take the multicast IP address and calculate its modulo to the amount of slots. For example, if the amount of slots is 16 (decimal) and multicast address is 01:00:5E:FF:FF:F9, then the slot number for that address can be 01:00:5E:FF:FF:F9 MOD 16=9 (decimal), see terminal #1. If the multicast address is 01:00:5E:FF:FF:F6, then the slot number for that address can be 01:00:5E:FF:FF:F6 MOD 16=6 (decimal), see terminal #2. If the multicast address is 01:00:5E:FF:FF:FD, then the slot number for that address can be 01:00:5E:FF:FF:FD MOD 16=13 (decimal), see terminal #3. In this example case length of one slot is DTIM period divided by 16. This is an example way to calculate slot distribution, but other algorithms could be provided too. (It is important to note for the convenience of the reader that while some numbers above are indicated as decimal, the ethernet address is in hexadecimal format because that is the common way to present Ethernet address.)

Another way to arrange address distribution to slots is to use preconfigured agreement, which tells slots where each address is associated, for example, a table of addresses and slots between devices. This table can be delivered over the air. Table or tables can also be built into devices and information to use certain table can be delivered over the air. The scope of the invention is not intended to be limited to any particular distribution algorithm. For example, the scope of the present invention is also intended to include using other distribution algorithms either now known or later developed in the future.

Based on this, and as shown, in the first DTIM, the AP sends packets for terminal #1 in time slots 9-13, packets for terminal #2 in time slots 6-7, and packets for terminal #3 in time slots 13-15. In these respective time slots, each terminal #1, #2 and #3 is in the receive mode indicated by “r”. In the remaining time slots 0-8 and 14-15, the terminal #1 is in the power save mode indicated by “ps”; in the remaining time slots 0-5 and 8-15, the terminal #2 is in the power save mode; and in the remaining time slots 0-12, the terminal #3 is in the power save mode. Note that terminals #1 and #3 receive overlapping packets in time slot 13.

In comparison, in the second DTIM, the AP sends packets for terminal #1 in time slots 9-13, packets for terminal #2 in time slot 6, and no packets for terminal #3 in time slot 13, instead terminal #3 receives the packets for terminal #1. In these respective time slots, each terminal #1, #2 and #3 is in the receive mode indicated by “r”. In the remaining time slots 0-8 and 14-15, the terminal #1 is in the power save mode indicated by “ps”; in the remaining time slots 0-5 and 7-15, the terminal #2 is in the power save mode; and in the remaining time slots 0-12 and 14-15, the terminal #3 is in the power save mode.

In operation, the receiving terminal such as #1, #2, #3 uses the same algorithm as the transmitting device (AP) to detect when it should be in the receive mode. This time slot distribution is called a multicast transmission map (MTMAP). When the present invention is used in some other system than WLAN, some other mechanism than DTIM period can be used to define a logical cycle time.

As discussed above, time slots can overlap with each other, as shown in the first DTIM, slot 13, which has packets for terminals 1 and 3, and the second DTIM, slot 13 which has packets that are received by terminal #1, as well as by terminal #3. Time allocated for each slot is limited and AP can continue sending packets in next slots. The term “slot” herein is not intended to mean that it is reserved only for one address, but instead means that transmission of multicast packets from a specific set of addresses starts at that time. FIG. 5 illustrates how packet sending continues in following slots. The AP can also continue packet sending in next DTIM period. The receiving terminal can detect the end of multicast transmission burst by receiving any multicast packet having its pending packet group bit disabled.

FIG. 5 also illustrates many important effects of the enhanced multicast transmission. For example, the biggest effect comes to terminal #2, which completely avoids receiving unwanted multicast packets. Terminal #2 can now spend almost all of the time in power-save mode, as shown. Also other terminals gain significant energy saving possibilities in this example. Even terminal #1, which listens to highest load multicast group can now spend ⅔ of its time in power save mode. FIG. 5 illustrates also how traffic in highest load multicast group 01:00:5E:FF:FF:F9 for terminal #1 spans over multiple slots and mixes with 01:00:5E:FF:FF:FD packets in slots 12 and 14. This is unavoidable because lots of multicast addresses fall into each slot. FIG. 5 also shows how terminals go into receive mode in the DTIM time to receive broadcast packets. The present invention does not affect broadcast behaviour. Moreover, the present invention also enables better power savings for those terminals that are not listening to multicast addresses. Now they can almost completely avoid receiving multicast packets, but they can still receive broadcasts at DTIM period.

For the sake of simplicity and brevity, FIG. 5 shows transmission using quite low transmission speed. For example, if transmission is done using 22 Mbs and one video stream is 384 kbs, a terminal that receives one stream must spend only about 2% of the cycle time in receive mode to receive this stream.

The invention is described using an IP multicast address or Ethernet multicast address. In the later case, the WLAN AP may be working as an ethernet switch/hub and may not be aware of an IP address, such as when the AP is working as a hub/switch between a wired ethernet and wireless WLAN. In this case, the AP may not use the IP address at all in packet handling discussions. The present invention may still be used because ethernet addresses may be distributed to slots. Consistent with that discussed above, the scope of the invention also includes mapping directly to IP addresses, because it is enough if the underlying network does not use ethernet addressing. Moreover still, the scope of the invention is also intended to include using another address that represents a multicast or broadcast address or a representation of a multicast group number.

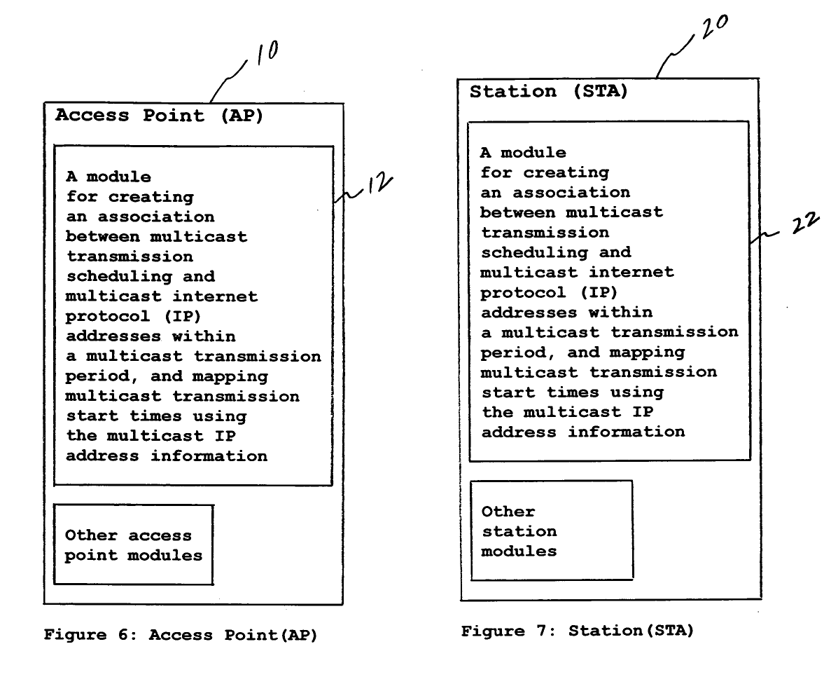

### FIGS. 6-7: Nodes, STAs, Points or Terminals

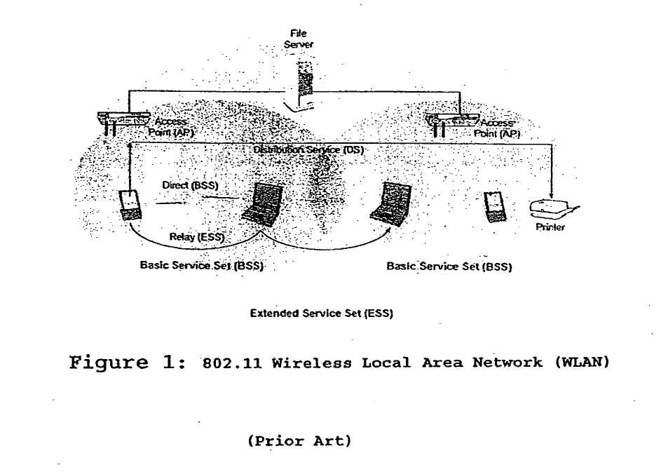

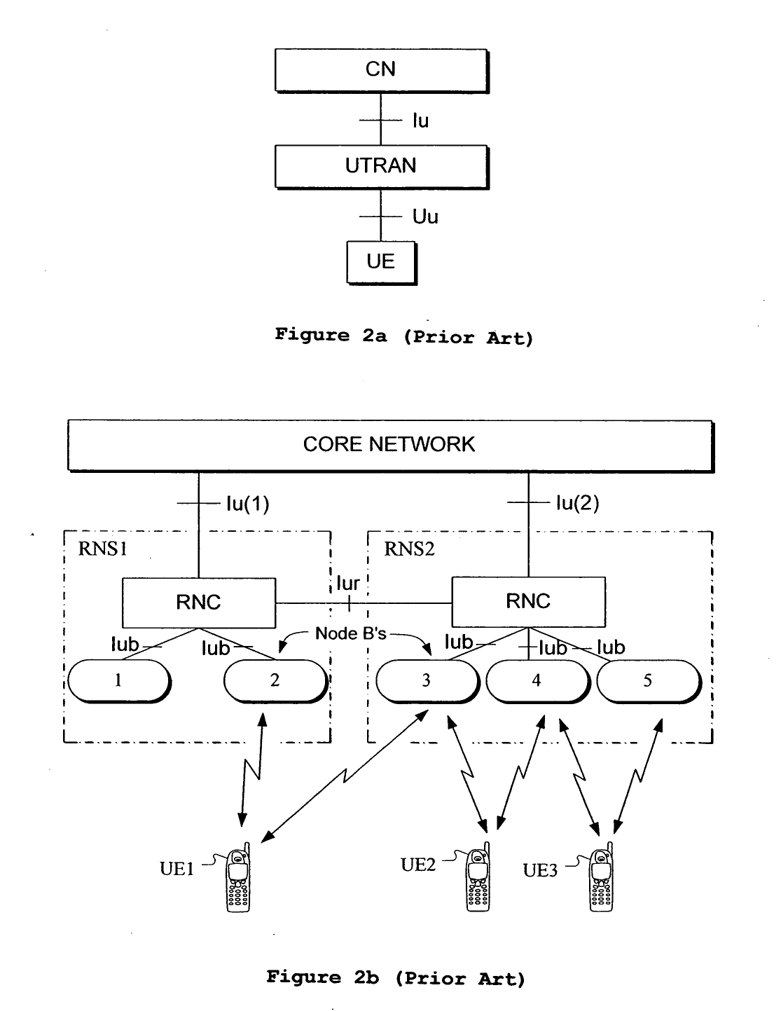

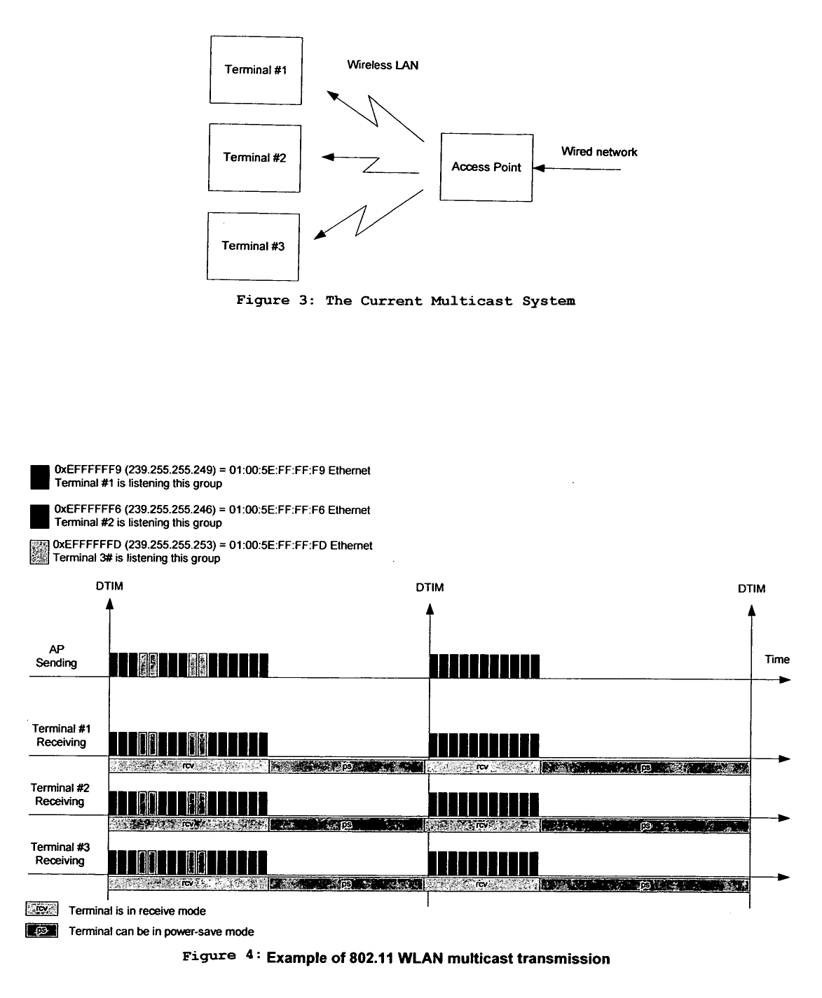

The two nodes, STAs, points or terminals in the WLAN may include an access point (AP) or other suitable network node or terminal 10 shown in FIG. 6 and a station (STA) or other suitable network node or terminal 20 shown in FIG. 7, for operating in a wireless LAN network consistent with that shown in FIG. 1 or 3. The AP 10 and the STA 20 have corresponding modules 12 and 22 for creating an association between multicast transmission scheduling and multicast internet protocol (IP) addresses within a multicast transmission period, and mapping multicast transmission start times using the multicast IP address information, consistent with that shown and described herein.

### The Basic Implementation

The basic implementation and cooperation of the AP 10 and STA 20 according to the present invention may include the following:

The IP layer software in, for example, the terminal #1, #2 or #3 in FIG. 5 may inform the MAC level to listen one or more multicast groups. The MAC level can now calculate MTMAP from addresses and adjust power save pattern according to that. If the terminal is not listening to any multicast groups it can skip all multicast transmission slots and stay in power save mode all the time except DTIM time. Terminal stays in power save mode until next transmission slot time is reached, and returns to receive more to be able to detect possible multicast packets. The terminal must stay in the receive mode until one of following happens:

a) The terminal detects any multicast packet having its pending packets slot bit clear, which tells the terminal explicitly that there are no more pending packet in this multicast group in this DTIM period until the slot time arrives in the next time. (As a general rule, the terminal must be in the receive mode at the slot time to receive multicast packets. If the traffic volume is high, the transmission can continue over the DTIM period. So the transmission can span to the next DTIM period. It is always safe for the AP to start sending buffered packets at the slot time. The AP can continue sending slots packets until it has sent one packet having groups pending packet bit in the MTMAP disabled. After sending that packet, the AP must buffer packets until slot time comes the next time.)
This is the best case. The terminal receives the last packet and can go to the power save mode.

b) Some multicast packets were detected but the slot bit is still on. In this case, the terminal may go to power save after next DTIM time.
This is the worst case. The last multicast packet was lost and there is no other multicast traffic. Receiving terminal can't know this, so it must stay in receive mode to receive possibly coming packets.

C) Multicast transmission slot allocated to address is over and no multicast packets arrive.
In this case, there is no multicast traffic at all or all packets from that slot are lost in transmission.

When the AP sends the last buffered packet for that multicast address, it clears the pending packets slot bit for that address from all following multicast packets sent in current cycle. As long as the AP is keeping slot bit up it may send packets from buffer for that address. When it has sent one packet with the slot bit disabled, it must cache all multicast packets from that address until the slot time comes again in next time (or cycle). If the transmission has spanned over the DTIM mark, then it means that the next receive time slot is inside the current DTIM period. The maximum delay caused by this buffering is now one DTIM cycle. The maximum delay is reached when a packet arrives from the wired network (see FIG. 3) to AP just after the multicast slot has passed, then the AP must cache the packet until the slot time comes in the next cycle.

This also means that when multicast transmissions use up the whole network capacity, and all the traffic belongs to the same multicast group, the MTMAP bit for this group stays on in every multicast packet.

If the AP has high volume unicast transmissions, it must prioritize by sending some buffered multicasts at slot times. This is done to ensure that STAs who are awake in the slot time get some multicasts, and stay awake after the slot is over to get the rest of their interesting packets.

The STA can return to power save while the slot time is still going on if it receives one packet having the interested addresses pending packets group bit disabled in the MTMAP. The AP does not send more packets associated to this group until the slot time comes the next time. This allows even better power savings in low volume traffic.

Because a receiving terminal can calculate listening points from the IP address, it can change the listening pattern without communicating to the AP. This is done by the terminal, when the software in the terminal is no longer interested in receiving packets from a certain multicast group. This is done also to receive packets from a new multicast group.

### Collision Avoidance

In the WLAN, terminals that are sending uplink unicast packets can determine the multicast continue map of bits from received multicast packets. In this way, the terminals can avoid collisions with the AP originated multicast transmissions. Of course, also existing WLAN collision avoiding mechanisms are used.

One optional improvement to reduce collision possibility with the terminal originated unicast transmissions is that the AP uses pending packets group bits in the DTIM to inform all terminals that there will be multicasts in certain time points in this cycle. Sending the same bitmap that is sent in multicast packets in DTIM packet can do this. Unicast sending terminals can now avoid transmission attempts at the start time of these specific multicast transmission slots. If the transmission bitmap is sent in a special DTIM message, any multicast-receiving terminal that gets this message can now see if there are multicast packets coming in this cycle. If packets are not expected, the terminal can skip its receiving slot and be in power save mode. On the other hand, requiring an AP that buffers data in a whole previous cycle to be able to deliver a multicast expected bitmap in the next DTIM cycle increases delay and buffer size requirements in the AP. The worst delay in this case may be two DTIM cycles.

### Dedicated Multicast Addresses for Power Savings

In addition, embodiments of the present invention are envisioned in which there can be e.g. 8 or 16 various Multicast IP addresses dedicated for power saving requesting devices with different characteristics (transmission start times & frequency of transmission start times), so that a WLAN AP can choose, based on the QoS and bitrate requirements of the ongoing multicast service/session/application, a suitable multicast transmission scheme—a dedicated multicast IP address for a particular multicast group. In this embodiment, other multicast groups that have not requested the power saving scheme can utilize all “free” areas of the DTIM time period.

### Support for Legacy DTIM

It is important to note that the legacy DTIM must still be supported for legacy clients. Legacy devices can be supported so that the whole WLAN steps back to legacy mode if one legacy terminal associates with the access point. It is possible that the DTIM information or information from multicast frame forces a slot based multicast client back to legacy DTIM transmission period usage when a legacy client associates to the access point. The AP and client exchange information about features in association set up.

### Implementation of the Functionality of the Modules 12 and 22

The functionality of the AP 10 and STA 20 described above may be implemented in the corresponding modules 12 and 22 shown in FIGS. 6 and 7. By way of example, and consistent with that described herein, the functionality of the modules 12 and 22 may be implemented using hardware, software, firmware, or a combination thereof, although the scope of the invention is not intended to be limited to any particular embodiment thereof. In a typical software implementation, the module 12 and 22 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 12 and 22 being a stand alone modules, as shown, or in the combination with other circuitry for implementing another module.

The other modules 14 and 24 in the AP 10 and STA 20 and the functionality thereof are known in the art, do not form part of the underlying invention per se, and are not described in detail herein. For example, the other modules 24 may include other modules that formal part of a typical mobile telephone or terminal, such as a UMTS subscriber identity module (USIM) and mobile equipment (ME) module, which are known in the art and not described herein.

### Implementation Without Modifying WLAN MAC Layer Packet Format

The present invention also includes an implementation with enhanced multicast implementation without modifications to current 802.11 MAC packets, which is a slightly modified implementation of enhanced multicast idea described above. This implementation is possible without modifications to current 802.11 MAC packet formats.

Another way to implement the present invention is to leave out the MTMAP field addition to packets. This approach allows implementation of this invention without modifying current 802.11 WLAN MAC packet format. In this way, it is easier to build backwards-compatible system. This implementation is not as optimized as implementation with MTMAP.

The basic idea of this implementation is to redefine the existing more data field from the multicast MSDU to have a slightly different meaning in the enhanced multicast system. The basic idea is still to buffer packets in the AP until address groups slot time arrives, and start sending then, just like described in the MTMAP implementation above. Now there is no MTMAP bitmap in each packet, but there is the more data field. The more data field usage is existing knowledge in IEEE 802.11 standards, but the present invention defines its function in the enhanced multicast network.

The more data field can only tell if there are multicast packets coming. In 802.11 WLAN, it can't describe exactly, which slots have pending packets, as the MTMAP implementation above would do.

Similar to the existing WLAN standard, the more data field in each multicast MSDU is used to inform recipients that there are buffered packets to be delivered in this DTIM cycle. When AP is sending the last buffered multicast packet, it disables the more data field from the last packet. In original 802.11 WLAN, STAs can go to power save mode until next DTIM period starts.

In the enhanced multicast system, STAs can go to the power save until the slot time associated with interesting addresses comes the next time. When the slot time is reached, the AP starts to send buffered multicast packets and the AP enables again the more data field for these packets. When the AP has no more packets to send, it disables the more data field from last packets.

The AP must not send packets having multicast address if it has already sent one packet having the more data field disabled. The AP must wait until addresses slot time is reached next time. Then it can start to send buffered packets having multicast addresses associated to this slot.

If the AP is sending packets from a previous slot and the next slot time is reached, the AP can start to send also packets belonging to that slot. The AP can continue this until it has sent one packet having the more data field disabled. After sending this kind of packet the AP must buffer packet until slot time for some buffered packets address is reached again.

When the STA receives one packet having the more data field disabled, it can decide if it can go to the power save mode. The decision can be made based on the same information as in implementation with MTMAP above. The AP will not start to send packets associated with a given slot until the slot time is reached the next time.

The AP can still send packets mixed from different slots, but it must ensure that the more data field is enabled while it is doing this. It must not send packets having those multicast addresses whose slot time has not been reached yet. It can start to send packets belonging to the next slot when the slot time is reached. It can still continue sending previous slots packets if it has not sent any packets having the more data field disabled.

The STA can stay in the power save mode until an interesting slot time is reached. Then it starts to either receive some multicast packets or it receives none. If it receives packets having the more data field enabled, it must stay in the receive mode until it receives one packet having the more data field disabled. If the STA does not receive any packets, it can go back to the power save mode until the next interesting slot time is reached.

The disadvantage of this approach is that receiving STAs must stay in the receive mode more frequently, because they can't make the power save decision from any received multicast packet. If the receiving STA wants to maximize the possibility to receive each interesting multicast packet, it must stay in the receive mode until it receives one packet having the more data field disabled. In the worst case, if this special last packet is lost, the STA stays in the receive mode over the rest of the cycle. AP can also start sending packets belonging to other slots. Because the MTMAP is not present, the STA has no information that there are no more interesting packets coming. The STA must receive and discard packets based on address information. In practice, the STA can also go to power save mode if it detects one non-interesting multicast packet having the more data flag disabled.

### Advantages/Disadvantages

The present invention also has the following additional advantages/disadvantages:

One advantage of the present invention is that the terminal can avoid receiving and processing most unnecessary data packets and stay in the power save mode for a longer time.

The disadvantage of this system is that it does not remove latency from multicast transmission. Latency is big problem with some interactive applications. Current 802.11 has also severe latency with multicast packets if one or more of the associated terminals is in power save mode. Moderate latency is not a critical problem with IPTV like use cases. DTIM interval can be adjusted to modify latency value. Short DTIM interval reduces latency, but increases also power consumption.

### WLAN AP Automatic and Dynamic Length Changes for DTIM Period

The following is a description of how a WLAN AP can change the length of the DTIM period automatically and dynamically. This feature is an addition to that disclosed above.

1. The Problem

One problem is that the DTIM period time is fixed. If the DTIM period time is too short, then terminals associated with the AP use more energy because they return from power save mode more often than with longer DTIM period. In a power saving sense, it is wise to have long DTIM period. In contrast, if the DTIM period time is too long, then the multicast bandwidth is very limited. There is longer latency before the AP can transmit buffered multicast packets. In video transfer, the AP can quickly run out of buffer space and drop packets. This causes more packet loss and that way reduction of quality. In performance sense DTIM period should be short.

In the prior art, the DTIM period could be hard coded or set manually to access point configuration. It is either too short to enable good power saving or too long to enable good bandwidth for multicast multimedia feeds. Worst is that the value is fixed. The feature described herein enables optimal balance between bandwidth and power saving.

2. The Improvement

The multicasting (IP multicast) video feed to mobile terminals over 802.11g WLAN allows receiving terminals to use power save mode all the time when receiving data. There is no need to go to the idle mode because multicast packets are not acknowledged by the terminal. This results in significant energy saving if compared to any unicast data receiving. In unicast receiving, the terminal must acknowledge each packet, so practically it must return from the power save mode each time when it receives a packet. If data transmission is frequent enough the terminal stays in the receive mode all the time, this is usually the case when terminals is receiving streamed unicast audio/video stream (RealVideo, Microsoft).

When there is one or more terminals in the power save mode, the WLAN access point (AP) buffers all multicast packets and sends them in the next DTIM (Delivery traffic indication message) time. The DTIM beacon is multiple on the WLAN beacon. Each associated terminal must return from the power save mode to the receive mode for possible multicast/broadcast transmit at the DTIM time. For example: If the beacon period is 100 ms and the DTIM factor is 3, then the DTIM transfer time is after every third beacon. In this example, the DTIM period is 3×100 ms=300 ms. Every terminal must return from the power save mode in every 300 ms to listen for possible DTIM broadcast.

It must be noted that this feature does not affect to unicast UDP/TCP transmission in WLAN network. The receiving terminal must acknowledge each unicast packet, so the power save mechanism described herein does not apply. The present feature does not improve terminal originated multicast traffic either. This feature is best applicable to multicast video/audio streaming from wired broadband network to terminals in wireless network where terminal is just receiving stream.

The improvement is for the WLAN access point to change the DTIM period dynamically, especially when there is lots of multicast traffic going to WLAN. When the multicast packet buffer starts to fill up, the AP can automatically decrease the DTIM period time to allow more frequent multicast bursts to WLAN. This reduces delay and increases overall multicast bandwidth, as well as reducing the buffering needs in the AP. When the buffer in the AP empties for some period of time, the AP can raise the DTIM period time back to a good power saving value. Now terminals can stay in the power save mode longer periods. The DTIM period modification can take place only in the beacon in next DTIM transmission. The DTIM period is transmitted in the beacon frame. This ensures that all terminals, even those in the power save mode, have a chance to hear new settings from beacon before it takes effect. In addition, embodiments are envisioned in which the distribution of addresses to slots are changed so that addresses match to the same time positions in the new DTIM period, because terminals may miss some beacons or it may take few cycles before everyone hears a new setup. If transmission times for addresses in the new setup match with those in the old setup, terminals are still able to receive packets.

Based on this technique, the AP does a DTIM period modification automatically and the modification is based on the amount and direction of the multicast traffic going to the WLAN. When this method is used, power saving and multicast throughput can be optimally balanced. There can be multiple values between maximum and minimum value to achieve optimal balance between power saving and multicast bandwidth.

The implementation of this feature must be done in the AP, which must monitor the multicast buffer size and notice if the traffic pattern seems to be multicast multimedia casting from the wired network to the wireless network (See FIG. 3). The traffic pattern can be recognised from the direction and the amount of multicast packets. When the traffic seems to rise above certain level, the AP reduces the DTIM period to allow more throughput. When there is less traffic, the AP raises the DTIM period. In operation, the AP checks the direction and the amount of multicast traffic to detect when multimedia streaming is going on.

It is understood that there must be certain upper limit to how long DTIM period can be. If there is only an ARP-like broadcasting in the WLAN, then the AP uses this upper limit value. A minimum DTIM period value is used when there is heavy multicast traffic from the wired network to the wireless network.

One advantage of this technique is that the DTIM period can be easily monitored in the WLAN, since it is broadcasted in every beacon. There is correlation between the amount of multicast traffic and the DTIM period length.

Moreover, another advantage of this technique is that it allows the building of WLAN access points having better multicast transmission throughput, less packet loss, and still enabling good power save functionality. Optimal power saving is very important in WLAN enabled mobile terminals. This feature could be used also in ad-hoc WLAN networking between mobile terminals. The best impact of this feature is in receiving IPTV like video feed from AP to terminal.

One disadvantage of this technique is that its application may cause backwards compatibility issues with badly implemented WLAN terminals. After all, adjusting the DTIM period based on multicast traffic can be provided to future WLAN standards or in WiFi certification. The DTIM period has real affects on both multimedia feed reception and power saving. Using multicast enables power saving options for mobile terminals. Better performance can be achieved if the DTIM period changes according to traffic profile.

### Changing DTIM Period Length at Run Time

The present invention also includes an implementation where the run time DTIM period changes. The implementation overcomes problems related information loss due to an unreliable transmission medium. Reasons for dynamic DTIM period functionality are described above.

The problem is that some receiving STAs may miss some beacons and this way they can't detect a new DTIM period setup for a while. The system may be designed so that even if some receivers are functioning based on old information, they can still receive multicast packets. This is not mandatory for implementing this changing DTIM period length feature, but it enables better performance.

In this implementation, there are only a limited amount of DTIM period setups that can be used. When the AP changes the DTIM period, it changes it to one of these supported setups. These setups are arranged so that slots in different setups have the same length. Also DTIM period starting points in longer DTIM setups match with starting points in shorter setups. The result of this arrangement is that the slot count is different in different setups.

This implementation defines a slot division and slot distribution mechanism so that the time when a multicast packet from a certain multicast group address will be transmitted matches to the slot defined in other possible setups. Slot numbering changes between setups, but the transmission time associated to certain multicast address stays the same at least at the start of a new setup.

The implementation can use a cyclic calculation like a modulo calculation to ensure that slot times for addresses overlap in the time domain. Also, predefined tables can be used instead of the modulo calculation.

In summary, this following shows a system using 8 and 16 slot setups. Also other setups, like a change from 64 to 256 could be used, as long as rules described herein are met. According to this implementation, the DTIM period change can go step-by-step from one setup to another, for example 4->8->16. Change can go also directly from one supported setup to another, for example 4->16.

If the number of slots in supported DTIM period lengths is evenly divisible 2, the amount of slots must be even with powers of two, like 2, 4, 8, 16, etc. The same result is reached by having slots numbered like 3, 9, 27, . . . and arranging the DTIM increases so that they are evenly divisible by 3. Also other similar arrangements can be chosen.

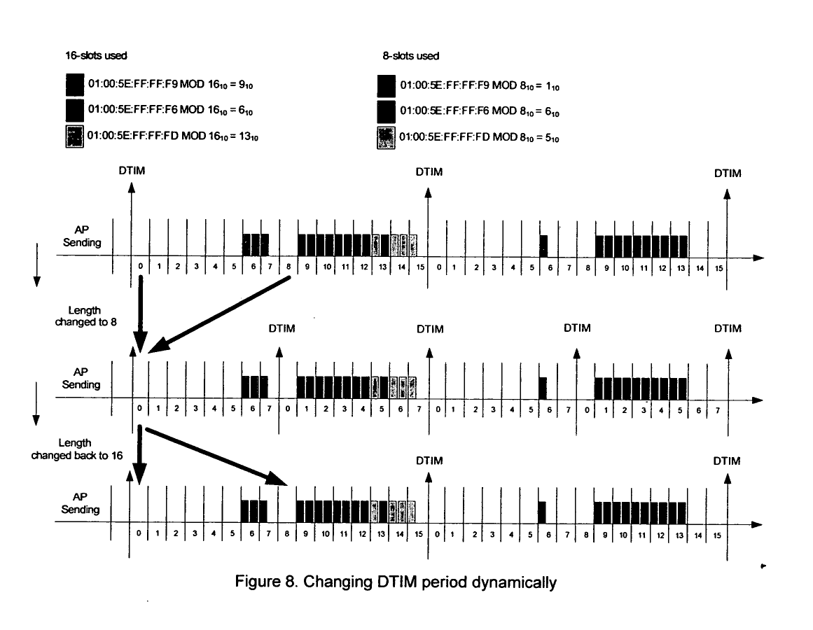

In this system, the modulo calculation can give an exact slot number for a given address and slot for a certain address stays at the same place in the time domain. FIG. 8 illustrates 8 and 16 slot setups of this implementation.

Also the slot length can be changed together or separately with the DTIM length change. In this case, the length of the slots and length of the DTIM period should be chosen so that the same addresses still overlap in the time axis. If the slot length is changed, the slot numbering arrangement should also be changed to achieve the functionality described below. Also some predefined numbering scheme could be chosen for address distribution to achieve match in time axis.

When the AP changes the DTIM period, it keeps the length of one slot constant. The target is to ensure that the slot allocations map between different setups as far as possible. With this arrangement it is easy to change from a shorter DTIM period to a longer period. STAs using listening pattern according to the old setup are still in the receive mode when multicast packets having the same address are transmitted using new setup.

If the STA receives a packet with MTMAP having too high pending packet bit enabled, it can easily calculate a matching slot from a current setup. For example, the STA believes that it is working in a network using an 8 slots DTIM period, then it receives multicast packet having MTMAP pending packet bit enabled for a slot number 14. The STA can now calculate that slot number 14 means slot number 6 (=14 MOD 7) in 8-slot system and there is pending packets for addresses associated to slot 8. There is no need to know the current DTIM setup to do this calculation. The STA relies on the fact that even if the AP has chosen another DTIM setup, the numbering in that is compatible with the previous setup. This help in a period change situation when the change signal has not yet reached all terminals.

When the STA receives a packet sent using a longer DTIM setup, it can always match that to a current setup. Also the pending packet bits in packets received from a shorter setup match directly to slots in longer setup.

When the AP changes the DTIM length, it must not continue sending packets belonging to already bypassed slots. The AP must wait until the slot of the address is reached the next time. This limitation ensures that pending packets bits are always valid for the new setup.

FIG. 8 sets forth an example of a system having DTIM period of 16 slots at the beginning. Then the AP changes the slot count to 8 slots, by this way reducing delay and buffering needs. For the next time, the AP changes back to a 16 slots long DTIM period. For brevity, FIG. 8 presents changes between an 8 and 16 slots DTIM period and doubles the period length.

At the top of the FIG. 8 is an example calculation of addresses in both example setups. FIG. 8 shows also how example packets used in previous figures are mapped to these setups.

FIG. 8 shows how example packets are associated to transmission slots in different setups.

At first in FIG. 8, the DTIM period is divided by 2 and the number of slots are reduced to half. The system goes from a 16 slot setup to an 8 slot setup. Black arrows visualize how example addresses belonging to slots 0 and 8 are now mapped to slot 0. Now terminal listening to certain multicast address spends twice as much time in the receive mode than in the 16-slot system. On the other hand, the delay caused by buffering is halved.

The second phase of FIG. 8 shows how the system transitions back from the 8 slot setup to the 16 slots setup. Now black arrows illustrate how addresses associated to slot 0 in 8 slot setup are now associated to slots 0 and 8.

FIG. 8 also shows how slot numbering in shorter setups (0-7) form the start of longer setups. Addresses in these slots are directly mapped same positions in other setups.

FIG. 8 also shows how DTIM period starting points match in different setups. The starting point at the longest possible setup is matched with starting points used on shorter setups. This enables easy transition from a shorter setup to a longer setup.

FIG. 8 shows also how multicast addresses are distributed to differently numbered slots in different setups. Even if slots are numbered differently in different setups, addresses are at same positions in time axis.

FIG. 8 shows how power savings options are affected in different setups. In the 16 slot setup, the STA listening for a given address spends half as much time in the receive mode, than in the 8 slot setup. FIG. 8 shows also how required buffering time at the AP and latency changes according to the DTIM period length.

When the DTIM period is decreased, the AP must keep a safety period before transmitting according to the new setup. While this safety period, the AP uses only those slots in the new DTIM cycles that match to slots in the previous setup. The AP buffers other packets. As FIG. 8 shows, the slot numbering in the shorter setups match directly to the numbering used in the beginning of the longer setup. This allows the STAs to catch up with change from beacons. Otherwise, the STAs following the old listening pattern may lose packets.

For example, in the setup and transition from the 16 slot setup to the 8 slot in FIG. 8, the setup allowed slots in the safety period are the slots numbered 0 to 7. In this example, the STAs listening according to the old setup may otherwise miss traffic associated to slots 8 to 15. In this example, the AP implements the safety period by sending packets only in every other DTIM period according to the new setups. After the safety period is over, the AP continues sending in the normal way according to new setup.

The length of this safety period can be configured to the AP. After the safety period is over, the AP can freely start sending according to the new setup. There is no need for the safety period if the DTIM length is increased, because the STAs listening according to the old shorter setup can always receive according to the new setup. That is the reason why slots are arranged so that they are in same position at time domain. The AP can also be implemented so that it does not use the safety period at all. This would result to some packet loss in situation where STAs have not received information about setup change.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What we claim is:

1. A method for communicating information between at least two nodes, points or terminals in a wireless local area network (WLAN) environment or other suitable network environment, characterized in that
the method comprises one or more steps for creating an association between multicast transmission scheduling and multicast internet protocol (IP) or ethernet addresses within a multicast transmission period, and mapping multicast transmission start times using the multicast IP or ethernet address information.

2. A method according to claim 1, wherein the method includes splitting the multicast transmission period into a number of time slots, each slot having one or more associated multicast addresses.

3. A method according to claim 2, wherein the method includes distributing the start of multicast transmissions to different time slots based on a multicast address of a packet.

4. A method according to claim 3, wherein the method includes a receiving terminal using the same algorithm as a transmitting device to detect when to be in the receive mode.

5. A method according to claim 1, wherein each multicast packet transmitted has a multicast transmission map of bits containing information about which multicast slots have more packets pending.

6. A method according to claim 5, wherein the multicast transmission map can be used by any node, point or terminal to immediately detect if there is still interesting packets coming in the present cycle.

7. A method according to claim 5, wherein a receiving terminal can use this information for making a decision whether it should stay in the receive mode or whether it can go to the power save mode and wait for next cycle.

8. A method according to claim 1, wherein a transmitting device (AP) and receiving devices (STA or mobile terminals) have prenegotiated rules when transmissions to various multicast groups will be effective within the multicast transmission period dedicated for multicast transmissions.

9. A method according to claim 8, wherein the prenegotiation rules are based on the multicast IP address, which can be used to map multicast transmission times for various multicast groups.

10. A method according to claim 8, wherein, with the knowledge of the multicast IP address of the multicast group, the receiving devices can know exactly the intended starting times for multicast transmissions for the specific multicast group.

11. A method according to claim 8, wherein various multicast IP addresses are dedicated for power saving requesting devices with different characteristics, including transmission start times and frequency of transmission start times, so that an access point (AP) can choose, based on the QoS and bit rate requirements of an ongoing multicast service/session/application, a suitable multicast transmission scheme.

12. A wireless local area network (WLAN) or other suitable network having at least two nodes or points that communicate information between the same, characterized in that
an association is created between multicast transmission scheduling and multicast internet protocol (IP) or ethernet addresses within a multicast transmission period, and multicast transmission start times are mapped using the multicast IP address information.

13. A wireless local area network (WLAN) or other suitable network according to claim 12, wherein the multicast transmission period is split into a number of time slots, each slot having one or more associated multicast addresses.

14. A wireless local area network (WLAN) or other suitable network according to claim 13, wherein the number of time slots depends on the length of the multicast transmission period.

15. A wireless local area network (WLAN) or other suitable network according to claim 13, wherein the start of multicast transmissions are distributed to different time slots based on a multicast address of a packet.

16. A wireless local area network (WLAN) or other suitable network according to claim 15, wherein a receiving terminal uses the same algorithm as a transmitting device to detect when to be in the receive mode.

17. A wireless local area network (WLAN) or other suitable network according to claim 12, wherein each multicast packet transmitted has a multicast transmission map of bits containing information about which multicast slots have more packets pending.

18. A wireless local area network (WLAN) or other suitable network according to claim 17, wherein the multicast transmission map can be used by any node, point or terminal to immediately detect if there is still interesting packets coming in the present cycle.

19. A wireless local area network (WLAN) or other suitable network according to claim 17, wherein a receiving terminal can use this information for making a decision whether it should stay in the receive mode or whether it can go to the power save mode and wait for next cycle.

20. A wireless local area network (WLAN) or other suitable network according to claim 12, wherein a transmitting device (AP) and receiving devices (STA or mobile terminals) have prenegotiated rules when transmissions to various multicast groups will be effective within the multicast transmission period dedicated for multicast transmissions.

21. A wireless local area network (WLAN) or other suitable network according to claim 20, wherein the prenegotiation rules are based on the multicast IP address, which can be used to map multicast transmission times for various multicast groups.

22. A wireless local area network (WLAN) or other suitable network according to claim 20, wherein both the transmitting device (AP) and the receiving devices (STA or mobile terminals) have prestored a dedicated algorithm, which is used for calculating transmission start times within the multicast transmission period based on the multicast IP address.

23. A wireless local area network (WLAN) or other suitable network according to claim 20, wherein, with the knowledge of the multicast IP address of the multicast group, the receiving devices can know exactly the intended starting times for multicast transmissions for the specific multicast group.

24. A wireless local area network (WLAN) or other suitable network according to claim 20, wherein various multicast IP addresses are dedicated for power saving requesting devices with different characteristics, including transmission start times and frequency of transmission start times, so that an access point (AP) can choose, based on the QoS and bit rate requirements of an ongoing multicast service/session/application, a suitable multicast transmission scheme.

25. A wireless local area network (WLAN) or other suitable network according to claim 17, wherein an access point uses pending packet group bits to inform all terminals that there will be multicasts in certain time points in the multicast transmission period.

26. A first node, point or terminal for communicating information to at least one second node, point or terminal in a wireless local area network (WLAN) environment, or other suitable network environment, characterized in that
the first node, point or terminal has a module for creating an association between multicast transmission scheduling and multicast internet protocol (IP) or ethernet addresses within a multicast transmission period, and mapping multicast transmission start times using the multicast IP or ethernet address information.

27. A first node, point or terminal according to claim 26, wherein the multicast transmission period is split into a number of time slots, each slot having one or more associated multicast addresses.

28. A first node, point or terminal according to claim 27, wherein the number of time slots depends on the length of the multicast transmission period.

29. A first node, point or terminal according to claim 27, wherein the start of multicast transmissions are distributed to different time slots based on a multicast address of a packet.

30. A first node, point or terminal according to claim 26, wherein the first node, point or terminal have prenegotiated rules when transmissions to various multicast groups will be effective within the multicast transmission period dedicated for multicast transmissions with the at least one second node, point or terminal.

31. A first node, point or terminal according to claim 30, wherein the prenegotiation rules are based on the multicast IP address, which can be used to map multicast transmission times for various multicast groups.

32. A first node, point or terminal according to claim 30, wherein both the first node, point or terminal and the at least one second node, point or terminal have prestored a dedicated algorithm, which is used for calculating transmission start times within the multicast transmission period based on the multicast IP address.

33. A first node, point or terminal according to claim 30, wherein, with the knowledge of the multicast IP address of the multicast group, the at least one second node, point or terminal can know exactly the intended starting times for multicast transmissions for the specific multicast group.

34. A computer program product with a program code, which program code is stored on a machine readable carrier, for carrying out the steps of a method comprising one or more steps for creating an association between multicast transmission scheduling and multicast internet protocol (IP) or ethernet addresses within a multicast transmission period, and mapping multicast transmission start times using the multicast IP or ethernet address information, when the computer program is run in a module of either a first node, point or terminal, such as an Access Point (AP), a second node, point or terminal, such as a station (STA), or some combination thereof.

35. A method according to claim 1, wherein the method further comprises implementing the step of the method via a computer program running in a processor, controller or other suitable module in one or more network nodes, points, terminals or elements in the wireless LAN network.

36. A first node, point or terminal according to claim 28, wherein the first node, point or terminal changes the multicast transmission period dynamically.

37. A first node, point or terminal according to claim 36, wherein the node, point or terminal is an access point in the WLAN and the multicast transmission period is the deliver traffic indication message.

38. A first node, point or terminal according to claim 37, wherein the modification is based on the amount and/or direction of the multicast traffic going to the WLAN.

39. A first node, point or terminal according to claim 26, wherein one node, point or terminal, including an access point (AP), dynamically changes the multicast transmission period based on traffic volume.

40. A method according to claim 8, wherein the prenegotiation of rules can be built in factory or negotiation can be done at run time over-the-air.

41. A wireless local area network (WLAN) or other suitable network according to claim 20, wherein the prenegotiation of rules can be built in factory or negotiation can be done at run time over-the-air.

42. A first node, point or terminal according to claim 30, wherein the prenegotiation of rules can be built in a factory or negotiation can be done at run time over-the-air.
